(19) United States
(12) Patent Application Publication
(10) Pub. No.: US 2009/0223120 A1
(43) Pub. Date: Sep. 10, 2009

(54) Plant Protection Device

(76) Inventor: Wolfgang Astner, München (DE)

Correspondence Address: HENRY M FEIEREISEN, LLC;HENRY M FEIEREISEN, 708 THIRD AVENUE, SUITE 1501, NEW YORK, NY, 10017, US

(21) Appl. No.: 12/093,885

(22) PCT Filed: Nov. 15, 2006
(86) PCT No.: PCT/DE06/02003

§ 371 Date: Oct. 6, 2008

(30) Foreign Application Priority Data
Nov. 16, 2005 (DE) 10 2005 055 063.0

(51) Int. Cl. A01G 13/00; A01G 13/02; A01G 13/04

(52) U.S. Cl. 47/32.1

(57) ABSTRACT

The invention relates to a plant protection device for protecting plants from low temperatures and which comprises the following characteristics: an inflatable, double-walled film sleeve (1), which forms in the inflated state an intrinsically rigid construction and has an interior volume adjusted to the size of the pot plant, and a base plate (3) which can be connected to the film sleeve (1) by a connecting device (2a, 2b), the base plate (3) being made of a cold-insulated material.

The invention relates to a housing for plants to be protected from low temperatures.

Greenhouses and hotbeds used for such purposes are known from prior art. However, under certain conditions, this prior art has disadvantages. For example, when single bucket plants big in size and accommodated on the balcony of an apartment house are to be protected from cold, they must be brought to a warmer place such as a garage or a greenhouse, before the winter time begins. Transportations of such kind require much work and can also affect growth and blooming behavior of plants.

Therefore, object of the invention is to provide a housing for big bucket plants having a height of about 1 meter up to 2 meters and a diameter of also 1 meter up to 2 meters in order to protect them from low temperatures safely and in a simple way.

This object is solved by a plant protection device according to claim 1. Advantageous further developments of the invention are claimed in the sub-claims.

The invention is described in more detail by means of an example in connection with the accompanying schematic drawings:

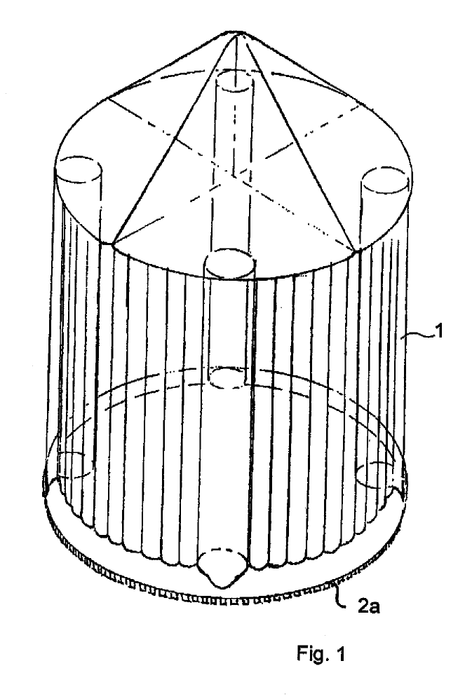

FIG. 1 shows an inflatable film sleeve provided with a connecting means.

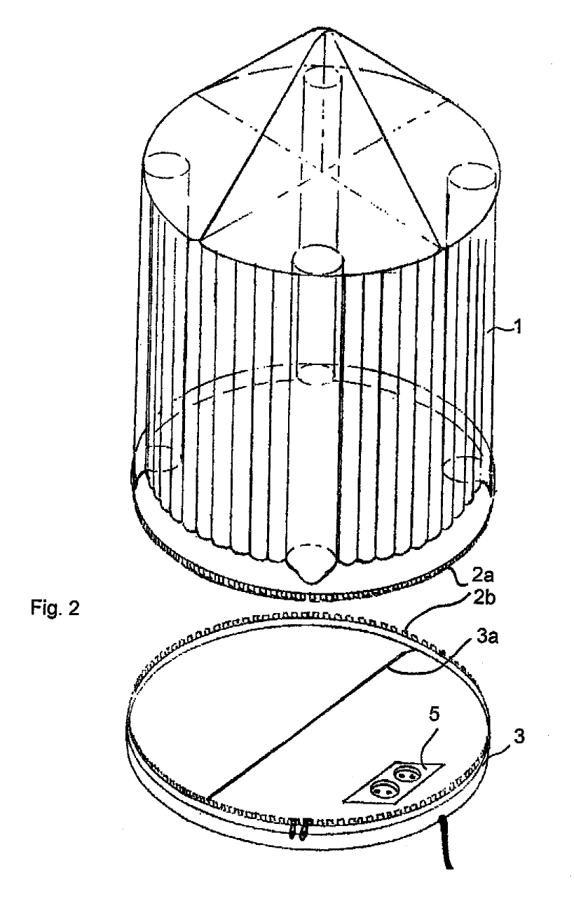

FIG. 2 shows the inflatable film sleeve and a base plate matched to it, in a state of assembling.

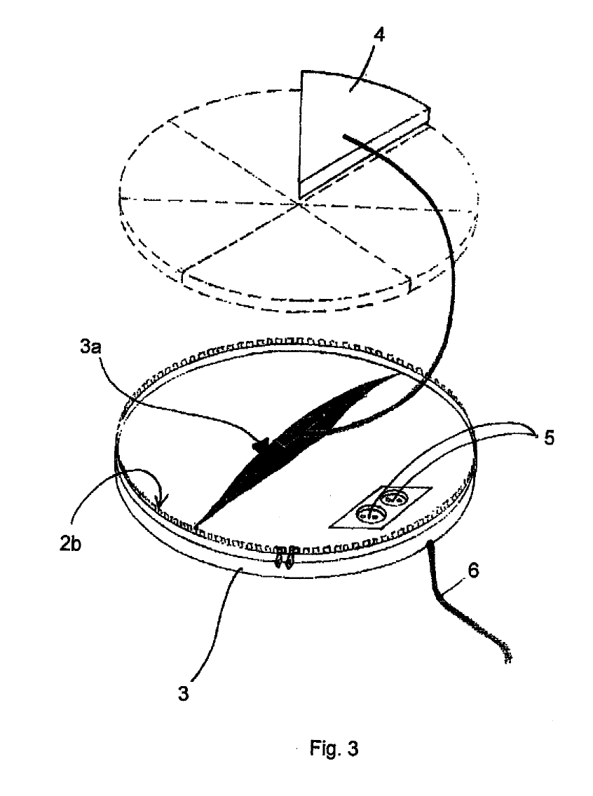

FIG. 3 shows the base plate in a state of mounting.

FIG. 1 shows a transparent double-walled sleeve 1 having an inherent rigidity. The column-like structure of the sleeve remarkably contributes to this inherent rigidity. Material and thickness of the film are chosen by an expert so that the film has a sufficient capability of resistance to typical mechanical loads such as those occurring when it is brought in contact with the plant. In addition, the film may not become brittle at wintry temperatures.

The film sleeve 1 is provided with a valve (not shown) and is inflated by using conventional technical means. At its lower edge, the film sleeve is provided with one half of a zip fastener (2a).

FIG. 2 shows the base plate of the device. The base plate consists of a sleeve 3 made of fabric and is provided with the other half of the zip fastener (2b). Eight plate segments 4 are arranged inside the fabric sleeve, which form a circular area when put together. The plate segments 4 are made of foamed plastic material having a good insulation property to lower temperatures. In addition, the base plate is provided with sockets 5 connected to a current supply. The sockets 5 serve to connect a heater with a thermostat included and a lighting means.

FIG. 3 shows all of the plate segments 4 of the base plate and the fabric sleeve 3 having a slot 3a through which the eight plate segments 4 can be inserted.

For mounting the device, at first, the base plate is assembled, followed by placing the bucket with the plant to be protected onto the base plate, by inflating the film sleeve 1 and by putting the inflated film sleeve over the plant. Finally, the two halves (2a, 2b) of the zip fastener are connected with each other. If necessary, a temperature-controlled electric heater and/or lighting elements can be installed before the film sleeve is placed. The lighting elements are fixed on loops or similar fastening means (not shown), which are arranged at the film sleeve.

1.-6. (canceled)

7. A plant protection device for protecting a bucket plant, comprising:
an inflatable double-walled film sleeve, which, when inflated, forms a structure having an inherent rigidity and has an inside volume matching a size of the bucket plant;
a base plate made of a cold-insulating material; and
a connecting unit for connecting the base plate to the film sleeve.

8. The plant protection device of claim 7, wherein the connecting unit is a zip fastener.

9. The plant protection device of claim 7, wherein the connecting unit is a hook-and-loop fastener.

10. The plant protection device of claim 7, further comprising an electric connection arranged on the base plate.

11. The plant protection device of claim 7, wherein the base plate is constructed to be dismountable.

12. The plant protection device of claim 7, further comprising fastening means for fastening electric lighting elements at an inside of the film sleeve.
